(19) United States
(12) Patent Application Publication
(10) Pub. No.: US 2013/0312840 A1
(43) Pub. Date: Nov. 28, 2013

(54) VALVE ACTUATOR SYSTEM

(71) Applicant: Terry Glenn Young, Longview, TX (US)

(72) Inventor: Terry Glenn Young, Longview, TX (US)

(73) Assignee: Array Holdings, Inc., Houston, TX (US)

(21) Appl. No.: 13/478,748

(22) Filed: May 23, 2012

(51) Int. Cl. F16K 31/126

(52) U.S. Cl. 137/15.19; 251/61.4

(57) ABSTRACT

A valve actuator apparatus and method for preventing latitudinal movement of a diaphragm actuator spring. The downstop is fitted with spring retainers to prevent latitudinal movement of the spring upon compression.

### FIELD

The present invention relates generally to valve actuators. More particularly the present invention relates to a valve actuator having improved reassembly ability and spring rotation prevention.

### BACKGROUND

A valve is a device that regulates the flow of a substance. Valves are produced in a variety of different styles, shapes and sizes. Typically, valves are used for gases and liquids. However, valves are also used on solids capable of flow, slurries or any other substance capable of flow. Valves are used in almost every industry having a substance that flows.

One type of valve is a gate valve, also referred to as a sluice valve. A gate valve opens by moving a blocking element from the path of flow. The blocking element may be a round disk, a rectangular element, or a wedge. Gate valves have a blocking element and a seat forming a substantially leak proof seal. In a gate valve, the blocking element can be referred to as a gate valve block, a gate block or a block. In the open position, a gate valve has a bore where the substance is allowed to partially or completely flow through the valve. In a gate valve, the bore may be referred to a gate valve bore. When the gate valve bore is across the valve bore the gate valve is in an open position. When the gate valve block is across the valve bore, the gate valve is in a closed position.

Gate valves may be operated manually or automatically. One method to automatically operate a gate valve is to use an actuator. An actuator is a mechanical device for moving or controlling a mechanism or system. When an actuator is used in a gate valve, the actuator is typically linked to a stem to repeatedly move the valve gate between open and closed positions.

Actuators to open and close the gate valves may include manual operators, diaphragm-type operators, pneumatic operators and hydraulic operators. Often, a manual operator is combined with a manual operator with a diaphragm-type, pneumatic or hydraulic operator for back-up and test purposes. Additionally, the actuator may include a bonnet assembly, which interconnects the valve body and the valve gate, and a bonnet stem which is movable with the gate via an operator.

A manual operator is often seen combined with diaphragm or hydraulic operator for back up purposes. These combinations generally result in a top shaft extending from the operator. The extension of the top shaft may indicate whether the valve is open or closed.

It is often desirable to be able to repair the actuator without changing the bonnet assembly. This may prove difficult in implementation however, because of the numerous moving parts.

A modified actuator with fewer moving parts may be desirable to overcome this obstacle.

An additional adjustment device on a valve actuator located within the actuator housing may be desirable to overcome these obstacles.

### SUMMARY

In general, various embodiments of the present invention pertain to an actuator for moving a valve gate between open and closed valve positions within a valve body, the actuator comprising: an actuator housing comprising a pressurizeable chamber with an inlet port and an unpressurized chamber; a diaphragm positioned within the actuator housing and with a proximal side and a distal side positioned between the pressurized and unpressurized chambers and a diaphragm retainer plate also having a proximal side and a distal side, the diaphragm retainer plate abutting the proximal side of the diaphragm; a spring having an outer diameter, the spring being longitudinally positioned between a downstop nut and a bonnet ring; and a downstop nut.

In such embodiments, the downstop nut has a proximal side and a distal side; the distal side abutting the proximal side of the diaphragm retainer plate; and a plurality of downstop spring retainers spaced annularly around the proximal side of the downstop nut, the downstop spring retainers having an inner side orientated toward the spring such that the distance from the inner side of a downstop spring retainer to the inner side of another downstop spring retainer 180 degrees apart is greater than or equal to the outer diameter of the spring.

Still further, in such embodiments, there may be present a top shaft having a proximal and distal end, the proximal end abutting the distal side of the downstop nut; and an operator shaft having a proximal and distal end, the distal end affixed to the downstop nut and the proximal end extending through a bore of an internal packing retainer fitted within an internal bore of a bonnet, the bonnet connected to the bonnet ring and the valve body.

In the aforementioned embodiments, it is contemplated that the spring is capable of producing a biasing force opposing axial movement of the operator shaft toward the valve body; and wherein the operator shaft within the actuator housing is movable toward the valve body and defining a shaft axis, the actuator housing having a bore therethrough for receiving the operator shaft.

In certain further embodiments, the use of a diaphragm retaining nut is contemplated, in such embodiments, at least a portion of the diaphragm retaining nut abuts the distal side of the diaphragm, and at least a portion of the diaphragm retaining nut extends through the diaphragm and into a diaphragm retainer plate bore, positioned within the diaphragm retainer plate, wherein the portion of the diaphragm retaining nut extending through the diaphragm is affixed to the diaphragm retainer plate bore. In such embodiments, the portion of the diaphragm retaining nut extending through the diaphragm retainer plate bore may be threaded into the diaphragm retainer plate bore. Still further, in certain embodiments the top shaft has a flange at its proximal end, and the flange is positioned within the diaphragm retainer plate bore between the diaphragm retaining nut and the downstop nut.

Still further, concerning the top shaft, the top shaft flange prevents movement of the top shaft in a distal direction through the diaphragm retaining nut. In additional embodiments concerning the top shaft, the top shaft possesses a groove perpendicular to the shaft axis and distal to the diaphragm retaining nut fitted with a snap ring. In such embodiments, the snap ring prevents movement of the top shaft in a proximal direction through the diaphragm retaining nut.

In further embodiments of the inventions disclosed herein, the downstop nut possesses a downstop nut peg on the distal side of the downstop nut and the top shaft possesses a top shaft bore located at the proximal end of the top shaft and adapted to receive the downstop peg.

Still further, in certain embodiments of the inventions disclosed herein concerning the plurality of spring retainers, it is contemplated that the plurality of downstop spring retainers may form a continuous loop having an inner diameter around the downstop, and wherein the inner diameter is greater than or equal to the outer diameter of the spring.

Still further, in embodiments pertaining to the spring retainers, it is contemplated that latitudinal movement of the spring is prevented by the downstop spring retainers. Likewise, expansion of the spring in a latitudinal direction may be prevented by the downstop spring retainers.

In further embodiments of the invention concerning the internal packing retainer, both the internal bore of the bonnet and the internal packing retainer are threaded and the internal bore of the bonnet is adapted to receive the internal packing retainer.

In further embodiments of the invention, the downstop nut is threaded internally and is adapted to receive a threaded portion of the distal end of the operator shaft.

Other embodiments of the invention pertain to a method of preventing latitudinal movement of an actuator spring of a diaphragm actuator, the method comprising: obtaining an actuator housing having a distal end connected to a pressurizeable chamber and a proximal end connected to a bonnet via a bonnet ring; obtaining a diaphragm retainer plate positioned between the pressurizeable chamber of the actuator and an unpressurized chamber; and obtaining a downstop nut. In such embodiments, the downstop nut possesses a proximal side and a distal side; the distal side abutting a proximal side of a diaphragm retainer plate, the diaphragm retainer plate positioned between a pressurizeable chamber of the actuator and an unpressurized chamber; and the downstop nut possesses a plurality of downstop spring retainers spaced annularly around the proximal side of the downstop nut, the downstop spring retainers having an inner side orientated toward the spring such that the distance from the inner side of a downstop spring retainer to the inner side of another downstop spring retainer 180 degrees apart is greater than or equal to the outer diameter of the spring;

In such embodiments the method further comprises installing an actuator spring in a longitudinal position with a distal end abutting the downstop nut and positioned between the plurality of downstop spring retainers, and a proximal end abutting the bonnet ring; and wherein pressurization of the pressurizeable housing moves the diaphragm retainer plate in a proximal direction thereby compressing the spring, and wherein the downstop spring retainers prevent horizontal expansion of the spring during compression, latitudinal movement of the spring during compression or both.

In certain embodiments, the method further comprises centering the downstop nut with respect to a top shaft and an operator shaft of the actuator, the centering comprising placing a downstop peg of the downstop nut into a partial bore at the proximal end of the top shaft, and affixing a distal end of the operator shaft to the proximal side of the downstop nut.

In certain embodiments, the method further comprises positioning the distal side of the downstop nut against the proximal side of the diaphragm retainer plate, and wherein the downstop nut is held against the diaphragm retainer plate by a longitudinal force of the spring.

Still further, in certain embodiments, the method contemplates that rotational movement of the actuator spring is prevented by the interaction between the downstop nut and the actuator spring; prevented by the interaction between the bonnet ring and the actuator spring, or both.

In certain embodiments, the method further comprises affixing the operator shaft to the downstop nut further by screwing the operator shaft into a threaded internal bore of the downstop nut. Concerning the operator shaft, the method may further comprise the operator shaft having a shoulder and wherein the shoulder abuts a distal end of the gate bore.

### BRIEF DESCRIPTION OF THE DRAWINGS

FIG. 1 is a cross sectional illustration of a diaphragm-type valve actuator in accord with the present invention.

FIG. 2 is a cross sectional illustration of a piston-type actuator depicting a downstop nut with downstop spring retainers.

FIG. 3 is a cross sectional illustration of a hydraulic-type actuator depicting a downstop nut.

FIG. 4 is a cross sectional illustration of diaphragm-type valve actuator specifically illustrating a downstop nut with a drift adjuster.

### LIST OF REFERENCE NUMERALS

diaphragm actuator 1
top actuator housing 2
lower actuator housing 3
actuator bolts 4
inlet port 5
pressure relief valve 6
upper plug 7
top shaft 8
seal retainer 9
rod wiper 10
top shaft seal 11
wear bearings 12
diaphragm retaining nut 13
operator shaft 14
top shaft groove 15
snap ring 16
top shaft flange 17
diaphragm 18
diaphragm retainer plate 19
downstop nut 20
central spring 21
bonnet ring 22
threaded holes 23
bolts 24
bonnet 25
internal packing retainer 26
drift shims 27
operator shaft o ring 28
packing retainer o ring 29
operator seals 30
vent fitting 31
operator shaft shoulder 32
operator shaft screw 33
bonnet bore 34
downstop spring retainers 36
downstop nut bore 37
top shaft bore 38
downstop peg 39
diaphragm retainer plate bore 40
spring interaction area 41
drift adjuster 50

### DETAILED DESCRIPTION

### Introduction

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Distal, in certain instances, can be defined as toward the top of the actuator and away from any valve on which the actuator rests.

Proximal, in certain instances, can be defined as toward a valve on which an actuator is mounted and away from the top of the actuator.

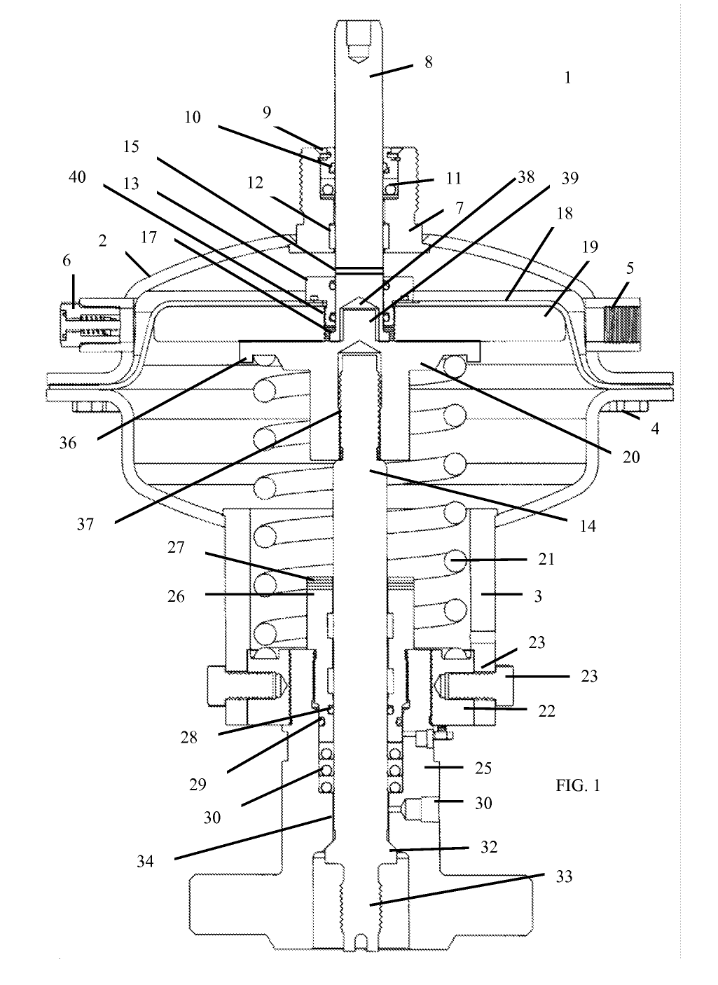

Referring now to the drawings, and more particularly to FIG. 1, a diaphragm actuator 1 is shown in the present invention. For the purposes of this description, the term distal may refer to a direction away from a valve and may refer to a direction toward a valve.

Referring to FIG. 1, the actuator has a top actuator housing 2 and a lower actuator housing 3. The top actuator housing is distal to the lower actuator housing and is bolted to the distal end of the lower actuator housing via a series of actuator bolts 4. Further, the top actuator housing 2 has a port for increasing or decreasing pressure hereafter referred to as an inlet port 5. The top actuator housing further comprises a pressure relief valve 6. At the distal end of the top actuator housing 2 is an upper plug 7 which is welded, cast, forged or screwed into the top actuator housing. The upper plug 7 has an internal bore for receiving a top shaft 8. Between the inner bore of the upper plug and the top shaft is a seal retainer 9 and a rod wiper 10. Proximal to the seal retainer and seal is a top shaft seal 11, which, in certain embodiments may be a Polypack™ seal. Proximal to the top shaft seal are wear bearings 12 which at least partially surround the top shaft 8. The seal retainer 9, the rod wiper 10 and the wear bearings 12 are preferably non-metallic to eliminate close tolerance problems which may be associated with the actuator top shaft. These components may be made of hard plastic like materials such as delrin, nylon, thermoplastics, resins, polyurethanes, phenolics, acetals, polyacrylates, epoxides, polycarbonates, polyester, aramids and the like.

The top shaft 8 fits through the upper plug 7 of the top actuator housing 2. The top shaft has a proximal end pointed away from the diaphragm and a distal end pointed toward the diaphragm. Further, the top shaft is preferably formed from stainless steel. The top shaft 8 is preferably large enough in diameter to prevent bucking stresses when loaded by a manual override or a hydraulic override. The proximal end of the top shaft passes through the diaphragm retaining nut 13 and interacts with the downstop nut 20.

In certain embodiments, the top shaft further has a top shaft groove 15 around the circumference of the top shaft and immediately proximal to the diaphragm retaining nut 13. The top shaft flange 17 on the distal end of the top shaft prevents upward movement.

As depicted in FIG. 1, the diaphragm 18 rests on the diaphragm retainer plate 19. Preferably the diaphragm 18 is made of nitrile laminated with several layers of nylon. Layers of nylon have an advantage of experiencing less wear from friction. Diaphragms may further include a stainless steel concentric insert seal ring bonded to the diaphragm which may come in contact with the diaphragm retaining nut 13. The diaphragm serves as a seal between the top actuator housing 2 and the lower actuator housing 3. Thus the area within the top actuator housing and the diaphragm can be considered to be a pressure chamber or a pressurizeable chamber and the area below or proximal to the diaphragm can be considered to be under atmospheric pressure, or an unpressurized chamber.

The diaphragm is held to the diaphragm retainer plate by the diaphragm retaining nut 13 which is positioned above or proximal to the diaphragm. The diaphragm retaining nut is preferably formed from stainless steel. Still further, the diaphragm retaining nut 13 is threaded and inserted through an opening in the center of the diaphragm 18 and screwed into the threaded diaphragm retaining plate 19, within the diaphragm retainer plate bore 40. Abutting the proximal side of the diaphragm retaining plate is a combination downstop and upper spring retainer that serves as both an upper spring retainer and a downstop, known as a downstop nut 20. The downstop nut 20 is preferably made of stainless steel. The distal end of the downstop nut forms a downstop peg 39 like protrusion fitting inside the proximal end of the top shaft, having a top shaft bore 39 adapted to receive the downstop peg.

One particular advantage of the downstop nut is the greater ease of assembly of the actuator by having fewer parts and in particular, fewer moving parts. In a conventional diaphragm actuator system, the upper spring retainer may disassociate from the downstop when the actuator is partially disassembled for adjustment of internal components. As a result, during assembly or reassembly, not only does the central spring (discussed below) need to be correctly positioned, the upper spring retainer needs to be correctly positioned as well. The development of the downstop nut 20 alleviates these problems.

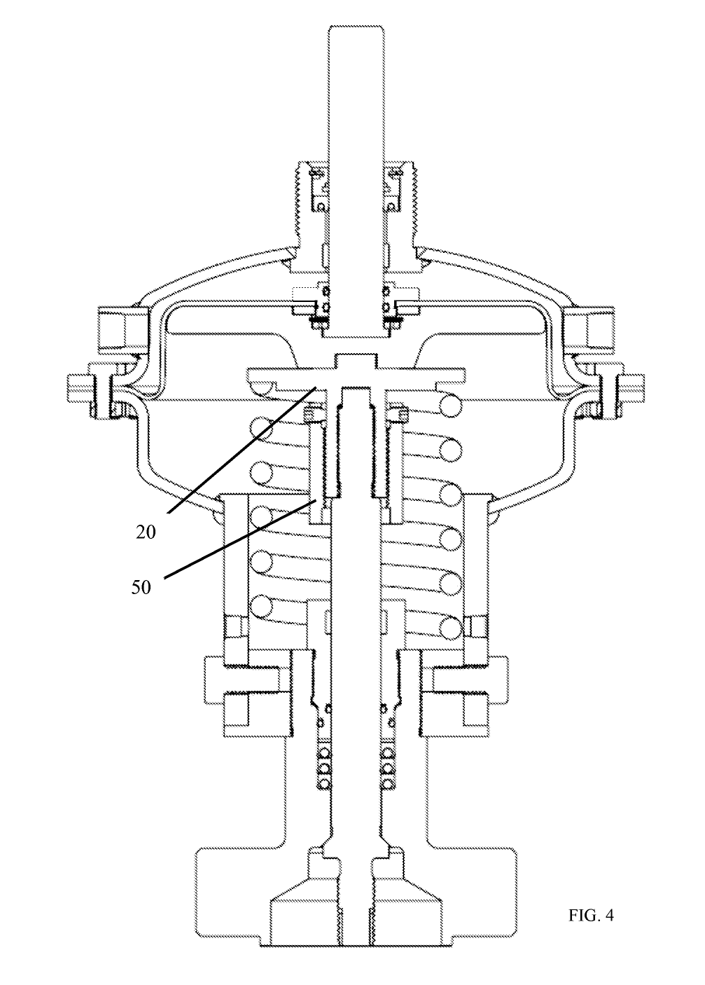

As an additional consideration, in certain embodiments, such as illustrated in FIG. 4, the use of a downstop nut 20 as opposed to a downstop and upper spring retainer allows for the installation of a drift adjuster 50. In a conventional system, the drift adjuster may hinder removal of an upper spring retainer. Likewise, a drift adjuster 50 attached to a downstop nut 20 may hinder installation of an upper spring retainer. Thus, the elimination of the upper spring retainer and downstop and replacement with the downstop nut can alleviate this problem.

Advantages of the downstop nut include the elimination of the extra task of trying to set a drift. By eliminating or combining an upper spring retainer ring to a downstop, both parts may be better centered within the actuator housing. Additionally, a one piece downstop is more economical in terms of worker time being spent during assembly and adjustment.

Further, the downstop nut possesses downstop spring retainers 36 as illustrated in FIG. 1, which prevent side to side or latitudinal movement of the spring which can otherwise start binding against the actuator housing. While FIG. 1 depicts two downstop retainers, they are generally contemplated to be arranged in an annular pattern around the edge of the downstop or as a continuous ridge around the edge of the downstop. Alternatively the downstop spring retainers 36 may be a single continuous ridge surrounding the downstop nut. Typically the downstop spring retainers are spaced annularly around the outer edge of the downstop such that the distance between the closest edges of two downstop spring retainers spaced 180 degrees apart from each other is the same distance or a slightly greater distance than the diameter of the central spring 21.

The downstop spring retainers further aid in the alignment of the spring within the actuator housing. Additionally, upon compression of the spring, the circumference of the spring can expand, causing the spring to shift in a latitudinal direction, thereby impacting alignment and causing the spring to have unwanted interactions with other components within the actuator. The downstop spring retainers

Still referring to FIG. 1, the distal end of the operator shaft 14 is threaded into and through the central axis of the downstop nut 20, such that it extends past the distal edge of the downstop nut. Preferably, this unthreaded portion of the operator shaft 14 is less than the inner diameter of the downstop nut. The threading within the central bore of the downstop nut 20 preferably will extend from the proximal end of the central bore to the distal end of the central bore. The portion of the operator shaft 14 which is screwed into the downstop nut 20 may comprise reciprocal threading the length of which may be the same as the length of threading of the central bore of the downstop nut 20.

Still referring to FIG. 1, the distal end of the operator shaft 14 is threaded into and through the central axis of the downstop nut 20 and into the downstop nut bore 37 such that it extends past the proximal edge of the downstop nut 20. Thus, the operator shaft 14 is affixed to the downstop nut. However, alternative methods of affixing the operator shaft 14 to the downstop nut exist. For instance, the operator shaft could be pinned, welded or forged with the downstop nut. In preferred embodiments, the distal end of the operator shaft 14 is threaded into the downstop nut bore 37. Preferably, the portion of the operator shaft 14 which extends past the distal edge of the downstop nut 20, and which is in direct connection with the top shaft 8 is not threaded. Preferably, this unthreaded portion of the operator shaft 14 is less than the inner diameter of the downstop nut. The threading within the central bore of the downstop nut 20, preferably will extend from the proximal end of the central bore to the distal end of the central bore. The portion of the operator shaft 14 which is screwed into the downstop nut 20 may comprise reciprocal threading the length of which may be the same as the length of threading of the central bore of the downstop nut 20.

In other aspects of FIG. 1, a central spring 21 surrounds the operator shaft. Preferably, the distal end of the central spring 21 is in contact with the downstop nut 20. Preferably the proximal end of the central spring 21 is in contact with the bonnet ring 22. The external circumference of the bonnet ring abuts the lower actuator housing 2. The internal bore of the bonnet ring is threaded. Preferably, to secure the bonnet ring 22 to the lower actuator housing 2, the bonnet ring 22 may have a series of threaded holes 23 of a defined circumference which are perpendicular to the operator shaft 14. Likewise, the lower actuator housing 2 may have a series of holes which are approximately the same circumference as the threaded holes 23 of the bonnet ring 22 and which are capable of aligning with the threaded holes 23 of the bonnet ring. Bolts 24 may be screwed into the threaded holes from the exterior of the lower actuator housing such that the lower actuator housing abuts the bonnet ring. Preferably the interface of the lower actuator housing with the bonnet ring is air tight.

As indicated previously, the internal bore of the bonnet ring is threaded. Threaded into the bonnet ring is the bonnet 25. Thus the actuator housing can be screwed onto the bonnet 25 via the bonnet ring 22. The tension on the central spring 21 can also be adjusted by rotating the actuator housing with respect to the bonnet. As illustrated in FIG. 1, the bonnet 25 comprises an internal bore. The distal portion of the internal bore is threaded so as to receive the internal packing retainer 26. The internal packing retainer 26 preferably surrounds the operator shaft 14. Distal to the internal packing retainer are drift shims 27. The drift shims 27 partially or completely surround the operator shaft 14. Drift shims 27 can be added or removed as required to increase or decrease the combined shim width.

The internal packing retainer has two o rings between its proximal and distal ends. O-rings are preferably Viton® o-rings. The operator shaft o-ring 28 surrounds the operator shaft 14 and is between the packing retainer 26 and the operator shaft 14. The packing retainer o ring 29 surrounds the internal packing retainer 26 and is in between the internal packing retainer 26 and the bonnet as illustrated in FIG. 1.

Importantly, the packing retainer of the present invention is an internal packing retainer. By having an internal packing retainer which is affixed to the internal bore of the bonnet, the packing retainer is more secure than a traditional packing retainer which sits over a bonnet stem and is secured by a screw in the side of the packing retainer. A secure internal packing retainer, which is not connected to the bonnet ring or actuator housing, will resist loosening or disassociating with the bonnet if the actuator housing is rotated, thereby preventing worker injury or fatality.

Proximal to the packing retainer and within the bore of the bonnet are operator seals 30. Preferably the operator seals are Polypack™ seals. Perpendicular to the bonnet and proximal to the operator seals is a vent fitting 31 which transverses the bonnet from the exterior to the bore of the bonnet.

At the proximal end of the bonnet as depicted in FIG. 1, the operator shaft 14 possesses an operator shaft shoulder 32 preventing upward or distal movement of the operator shaft through the bonnet bore 34 Proximal to the operator shaft shoulder 32 is an operator shaft screw 33.

In the operation of this improved diaphragm actuator 1 of the present invention, pressure is applied through inlet port 5 in order to move both the diaphragm 18 and the diaphragm retainer plate 19 proximally toward the bonnet 25. The movement engages the downstop nut 20 to move the operator shaft 14 proximally toward the bonnet 25, until the downstop nut 20 contacts the drift shims 27. At this point, further movement in a proximal direction is prevented by the interaction between the downstop nut 20 and the drift shims 27. Further, at this point in operation, the operator shaft 14, which may be attached to a gate within a gate valve, will have repositioned the gate from a closed position to an open position.

Although the foregoing embodiments have focused on a diaphragm type actuator. It is conceivable and expected that the reduction in number of actuator parts afforded by the use of the downstop nut may be implemented in other actuator types.

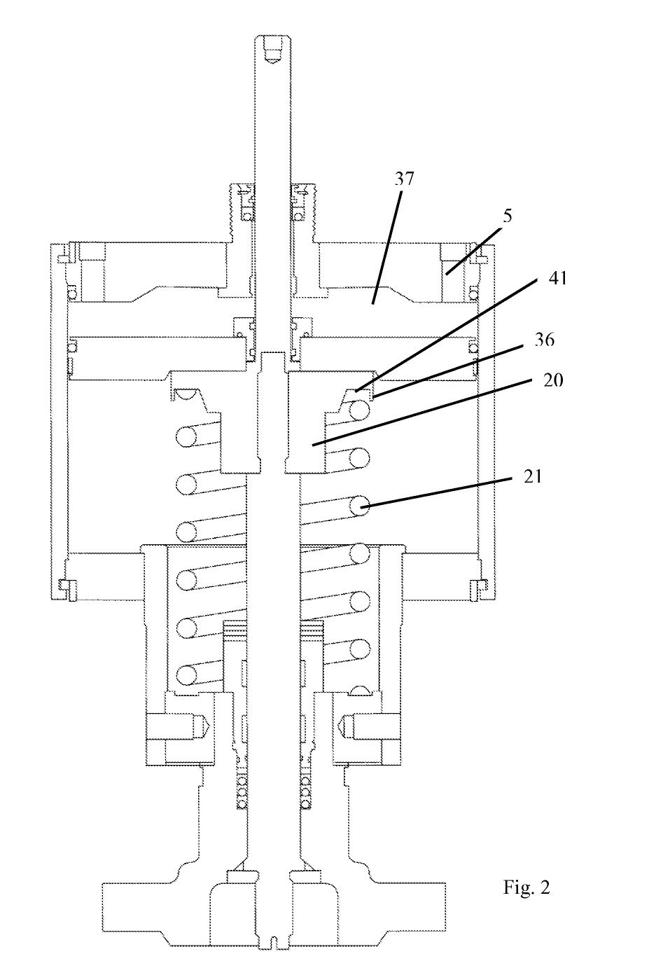

FIG. 2 is a cross sectional illustration of a piston type actuator with a fused upper spring retainer and downstop, i.e. the downstop nut 20. This embodiment has an inlet port 5 for the introduction of pressure into a pressure chamber 37. A pressure relief valve may be fitted on one port as is also found in a diaphragm type actuator. Typically the pressure will be pneumatic pressure, however it is conceivable that other types of pressure may be used in this actuator type, such as hydraulic pressure. The pressure in the pressure chamber 37 results in a downward or proximal movement of the piston, compressing the central spring 21. The central spring is held in place at least partially by the downward angled downstop spring retainers, which are positioned in manner equal to or greater than the diameter of the central spring 21. The downstop spring retainers rise in a proximal direction from the spring interaction area 41 of the downstop nut. Alternatively the downstop spring retainers 36, in this embodiment, may be a single continuous ridge surrounding the downstop nut. In addition to the aforementioned benefits of a reduction in the number of parts by employing a downstop nut, the downstop spring retainers 36 aid in the prevention of side to side or latitudinal movement of the central spring 21 which could otherwise start binding against the actuator housing.

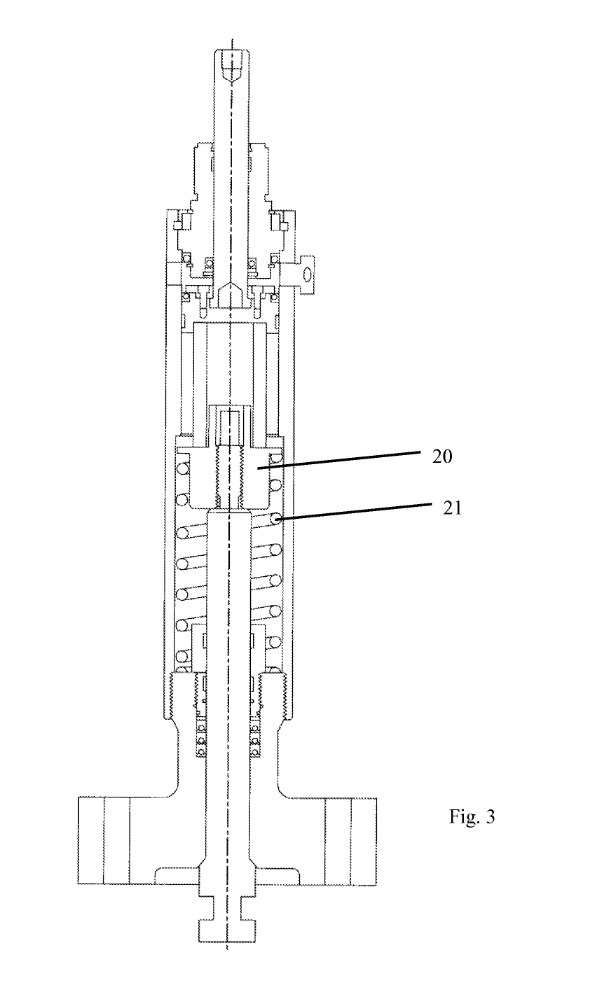

As illustrated in FIG. 3, the fused upper spring retainer and downstop, i.e. the downstop nut 20, may be employed in a more traditional hydraulic actuator. Although this particular actuator has a narrow actuator housing to prevent any side or latitudinal movement of the central spring 21, in certain embodiments, downstop retainer rings may be used if the actuator housing is otherwise wide enough to allow for side or latitudinal movement of the central spring.

The foregoing detailed disclosure and description of the invention is illustrative and explanatory thereof, and it will be appreciated by those skilled in the art, that various changes in the size, shape and materials as well as in the details of the illustrated construction, reliability configurations, or combination of features of the various valve actuator elements of the present invention may be made without departing from the spirit of the invention.

1. An actuator for moving a valve gate between open and closed valve positions within a valve body, the actuator comprising:
a. an actuator housing comprising a pressurizeable chamber with an inlet port and an unpressurized chamber;
b. a diaphragm positioned within the actuator housing and with a proximal side and a distal side positioned between the pressurized and unpressurized chambers and a diaphragm retainer plate also having a proximal side and a distal side, the diaphragm retainer plate abutting the proximal side of the diaphragm;
c. a spring having an outer diameter, the spring being longitudinally positioned between a downstop nut and a bonnet ring;
d. a downstop nut having:
i. a proximal side and a distal side; the distal side abutting the proximal side of the diaphragm retainer plate; and
ii. a plurality of downstop spring retainers spaced annularly around the proximal side of the downstop nut, the downstop spring retainers having an inner side orientated toward the spring such that the distance from the inner side of a downstop spring retainer to the inner side of another downstop spring retainer 180 degrees apart is greater than or equal to the outer diameter of the spring;
e. a top shaft having a proximal and distal end, the proximal end abutting the distal side of the downstop nut;
f. an operator shaft having a proximal and distal end, the distal end affixed to the downstop nut and the proximal end extending through a bore of an internal packing retainer fitted within an internal bore of a bonnet, the bonnet connected to the bonnet ring and the valve body; and
wherein the spring is capable of producing a biasing force opposing axial movement of the operator shaft toward the valve body; and wherein the operator shaft within the actuator housing is movable toward the valve body and defining a shaft axis, the actuator housing having a bore therethrough for receiving the operator shaft.

2. The actuator of claim 1, further comprising a diaphragm retaining nut, at least a portion of the diaphragm retaining nut abutting the distal side of the diaphragm, and at least a portion of the diaphragm retaining nut extending through the diaphragm and into a diaphragm retainer plate bore, positioned within the diaphragm retainer plate, wherein the portion of the diaphragm retaining nut extending through the diaphragm is affixed to the diaphragm retainer plate bore.

3. The actuator of claim 2, wherein the portion of the diaphragm retaining nut extending through the diaphragm is threaded into the diaphragm retainer plate bore

4. The actuator of claim 2, wherein the top shaft has a flange at its proximal end, and wherein the flange is positioned within the diaphragm retainer plate bore between the diaphragm retaining nut and the downstop nut.

5. The actuator of claim 4, wherein the top shaft flange prevents movement of the top shaft in a distal direction through the diaphragm retaining nut.

6. The actuator of claim 2, wherein the top shaft possesses a groove perpendicular to the shaft axis and distal to the diaphragm retaining nut fitted with a snap ring.

7. The actuator of claim 5, wherein the snap ring prevents movement of the top shaft in a proximal direction through the diaphragm retaining nut.

8. The actuator of claim 1, wherein the downstop nut possesses a downstop nut peg on the distal side of the downstop nut and wherein the top shaft possesses a top shaft bore located at the proximal end of the top shaft and adapted to receive the downstop peg.

9. The actuator of claim 1, wherein the plurality of downstop spring retainers form a continuous loop having an inner diameter around the downstop, and wherein the inner diameter is greater than or equal to the outer diameter of the spring.

10. The actuator of claim 1, wherein latitudinal movement of the spring is prevented by the downstop spring retainers.

11. The actuator of claim 10, wherein expansion of the spring in a latitudinal direction is prevented by the downstop spring retainers.

12. The actuator of claim 1, wherein both the internal bore of the bonnet and the internal packing retainer are threaded and the internal bore of the bonnet is adapted to receive the internal packing retainer.

13. The actuator of claim 1, wherein the downstop nut is threaded internally and is adapted to receive a threaded portion of the distal end of the operator shaft.

14. A method of preventing latitudinal movement of an actuator spring of a diaphragm actuator, the method comprising:
a. obtaining an actuator housing having a distal end connected to a pressurizeable chamber and a proximal end connected to a bonnet via a bonnet ring;
b. obtaining a diaphragm retainer plate positioned between the pressurizeable chamber of the actuator and an unpressurized chamber;
c. obtaining a downstop nut having:
i. a proximal side and a distal side; the distal side abutting a proximal side of a diaphragm retainer plate, the diaphragm retainer plate positioned between a pressurizeable chamber of the actuator and an unpressurized chamber; and
ii. a plurality of downstop spring retainers spaced annularly around the proximal side of the downstop nut, the downstop spring retainers having an inner side orientated toward the spring such that the distance from the inner side of a downstop spring retainer to the inner side of another downstop spring retainer 180 degrees apart is greater than or equal to the outer diameter of the spring;
d. installing an actuator spring in a longitudinal position with a distal end abutting the downstop nut and positioned between the plurality of downstop spring retainers, and a proximal end abutting the bonnet ring; and
wherein pressurization of the pressurizeable housing moves the diaphragm retainer plate in a proximal direction thereby compressing the spring, and wherein the downstop spring retainers prevent horizontal expansion of the spring during compression, latitudinal movement of the spring during compression or both.

15. The method of claim 14, further comprising centering the downstop nut with respect to a top shaft and an operator shaft of the actuator, the centering comprising placing a downstop peg of the downstop nut into a partial bore at the proximal end of the top shaft, and affixing a distal end of the operator shaft to the proximal side of the downstop nut.

16. The method of claim 15, further comprising positioning the distal side of the downstop nut against the proximal side of the diaphragm retainer plate, and wherein the downstop nut is held against the diaphragm retainer plate by a longitudinal force of the spring.

17. The method of claim 16, wherein rotational movement of the actuator spring is prevented by the interaction between the downstop nut and the actuator spring.

18. The method of claim 17, wherein rotational movement of the actuator spring is further prevented by the interaction between the bonnet ring and the actuator spring.

19. The method of claim 15, wherein affixing the operator shaft to the downstop nut further comprises screwing the operator shaft into a threaded internal bore of the downstop nut.

20. The method of claim 19, wherein the operator shaft further comprises a shoulder and wherein the shoulder abuts a distal end of a gate bore.
